(19) United States
(12) Patent Application Publication
(10) Pub. No.: US 2010/0169164 A1
(43) Pub. Date: Jul. 1, 2010

(54) BALANCED SCORE-CARD SYSTEM AND METHOD FOR ESTABLISHING THE SAME

(76) Inventor: CHAO-WU HUANG, TAIPEI CITY (TW)

Correspondence Address: CHAO-WU HUANG, 5F., No 33, Aly. 7. Ln, 170, Dongxin St., Taipei City, 115, TW

(21) Appl. No.: 12/642,851

(22) Filed: Dec. 20, 2009

(30) Foreign Application Priority Data
Dec. 31, 2008 (TW) 97151557

(51) Int. Cl. G06Q 10/00

(52) U.S. Cl. 705/10; 705/347

(57) ABSTRACT

Provided is a Balanced Score-Card system, and a method for establishing the same. The balanced Score-Card particularly includes an item-setting module, a SWOT-matrix module, a SWOT overall-objective setting module, an overall-objective setting module, a causality setting module, and a strategic-map module. The SWOT overall-objective setting module is set via a SWOT-matrix module with reversible and recording mechanism. Therefore, a user may obtain a logic relation between a strategic objective and a strategic condition through this SWOT-matrix module, and also understand the importance of every strategic condition. Further, the strategic condition can be examined whether it has error. Consequently a more accurate Balanced Score-Card system can be established.

### BACKGROUND OF THE INVENTION

1. Field of the Invention

The present invention generally relates to a Balanced Score-Card system and a method for establishing the system, more particularly to the Balanced Score-Card system having a SWOT matrix with reversible and recordable function.

2. Description of Related Art

The Balanced Score-Card is a manner used to visualize the evaluation of business achievement including the vision and strategy that concerns the performance of an enterprise. The Balanced Score-Card introduces four elements including finance, customer, internal business processes, learning and growth to constitute strategies. These four elements are not independent from each other. A key-performance index of the strategic subject forms a vertical causality. Via this causality, an integrated strategy is developed. In addition, in the procedure of introducing the Balanced Score-Card, a SWOT analysis-and-strategy matrix and a selection of strategy matching are the more important processes.

The mentioned SWOT analysis is a comparative analysis method for the strength crisis, which is a scheme for analyzing the competitive situation of the enterprise. This method is instituted before the development of the enterprise, and is one of the schemes for analyzing the marketing, especially for the enterprise performing comprehensive analysis and orientation. Via the mentioned selection of SWOT matrix strategy, the arrangement of matrix is used to assist a planner to perform a multiple-to-multiple matching of the information after analyzing the internal and external circumstances.

However, the SWOT-matrix strategy is focused on the rational and accurate determination and deduction of the circumstance information. Further, a targeted strategic subject can be correspondingly provided in the circumstances including a competitive advantage (OS), a crisis turning point. (TS), competitive disadvantage (OW) and instant crisis. Furthermore, a expected alternative strategy can be obtained from an internal matrix matching process. Next, this alternative strategy is used to process an attractiveness analyzing for confirming a primary strategy and a secondary strategy. Then the system performs matching and modification on the primary strategy, secondary strategy, and the strategic subject, and uses the modified strategic subject to be a base for instituting a strategic map and a objective for the enterprise.

Nevertheless, the SWOT matrices currently adopted by the enterprises are the strategic items which are mostly instituted based on the practical experiences or their self-subjective meaning. When those strategic items implemented based on the above-described conditions are not as expected, the entrepreneurs will consider the conventional procedure has no any logical thinking and relevant record since those strategic items are based on the entrepreneurs' experiences. The conventional way adopting the SWOT matrix has a drawback on the institution since it can not accurately figure out the reasons, weights and evaluations regarding to the strategies.

### SUMMARY OF THE INVENTION

One of the objects of the present invention is to make an enterprise capable of recording the instituting process of every strategic item using different scheme. In which, the way used to establish the SWOT strategic matrix is in compliance with a logical thinking in order to achieve a recordable function and reversible deduction.

A Balanced Score-Card system is provided. The system provides an item-setting module having a index-related setting and a SWOT-matrix module having a logical relation and recording mechanism. Further, a SWOT overall-objective setting module for setting SWOT overall objective based on the SWOT-matrix module is included. Still further, a strategic-matching module connected to the SWOT-matrix module is included to perform a matching on the strategic subject and the SWOT strategy. An overall-objective setting module connected to the index-related setting is further included for setting an overall objective of the Balanced Score-Card system. Further, a causality setting module connected to the overall-objective setting module is included, and used to set the causality for each objective in the overall-objective setting module based on the index-related setting. A strategic-map module is further used to create a strategic map based on the causality of each item, and the strategic map is outputted to a front module of the Balanced Score-Card for displaying.

The present invention provides a relevant method for establishing a Balanced Score-Card. The method particularly includes a first step of installing an item-setting module, a next step of instituting a strategic condition having at least one number or character. Further, a SWOT-matrix module of a strategic objective is then established based on the strategic condition. Through the SWOT-matrix module, an overall-objective setting module is set. According to the index-related setting and the SWOT overall-objective setting module of the item-setting module, the overall objective of the scheme of Balanced Score-Card is done. Setting causality for each strategic objective is to establish a causality setting module. Furthermore, a strategic-map module is created via the causality of every strategic objective. After that, the strategic map is outputted to the front module of Balanced Score-Card for displaying.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of the Balanced Score-Card system in accordance with the present invention;

FIG. 2 is a schematic diagram of the SWOT-matrix module according to the preferred embodiment of the present invention;

FIG. 3 shows a flow chart of the method for establishing the Balanced Score-Card.

### DETAILED DESCRIPTION OF THE PREFERRED EMBODIMENTS

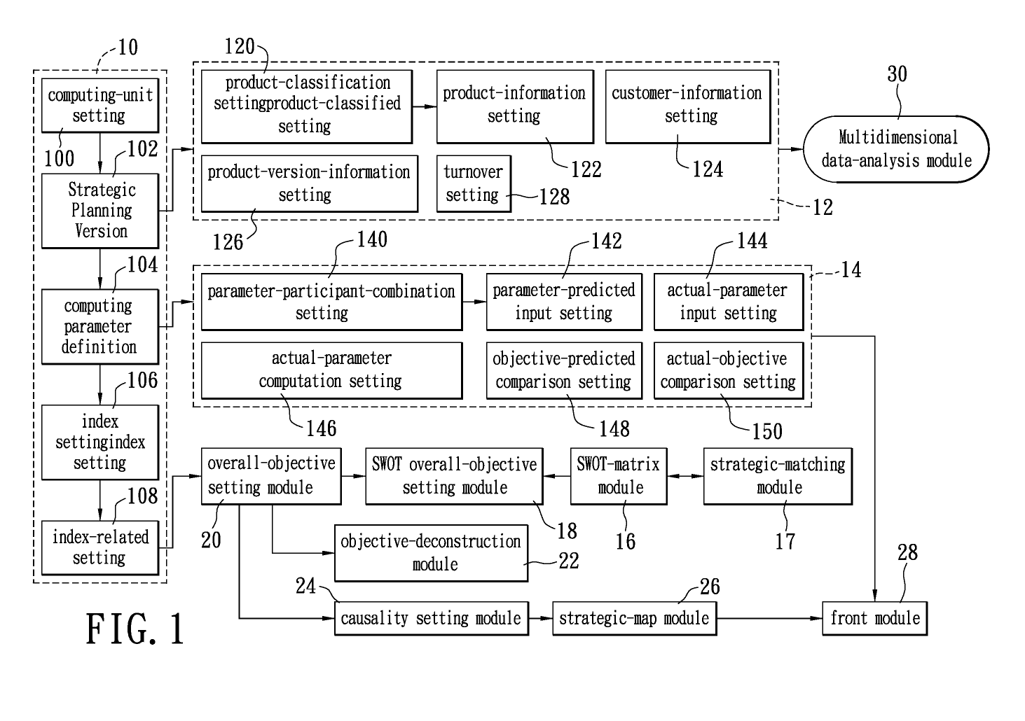

Reference is made to FIG. 1 showing a schematic diagram of Balanced Score-Card system. The system particularly includes an item-setting module 10, a product-analysis module 12, a parameter-setting module 14, a SWOT-matrix module 16, a strategic-matching module 17, a SWOT overall-objective setting module 18, an overall-objective setting module 20, a objective-deconstruction module 22, a causality setting module 24, a strategic-map module 26, a front module 28, a multidimensional data-analysis module 30.

The item-setting module 10 further includes a computing-unit setting 100, a strategic planning version 102, a computing parameter definition 104, an index setting 106, and an index-related setting 108.

The product-analysis module 12 is created based on the content of the strategic planning version 102. The module 12 has a product classification setting 120, a product-information setting 122, a customer-information setting 124, a product-version-information setting 126, and a turnover setting 128.

Since the mentioned strategic planning version 102 at each time has different content, the content setting of the product-analysis module 12 is hence different. The product-classification setting 120 is to classify the product at each strategic planning. Further, the product-information setting 122 is to set the customer information according to classification of product by the product-classification setting 120. The customer-information setting 124 is to set the relevant customer information. The product-version-information setting 126 is to set a version information of the product according to the content of the product-information setting 122, in order to facilitate the maintenance of the product. The turnover setting 128 is used to set the monthly or annual turnover regarding the sold products.

The parameter-setting module 14 is created based on definition of the computing parameter definition 104, and in which the related parameters are provided for the backend to use. The parameter-setting module 14 further provides every type of setting, including a parameter-participant-combination setting 140, a parameter-predicted input setting 142, a actual-parameter input. setting 144, a actual-parameter computation setting 146, a objective-predicted comparison setting 148, and a actual-objective comparison setting 150.

The mentioned combination setting (140) of the parameters and the participants is based on the content of strategic planning version 102. The parameter-predicted input setting 142 is used to input a prediction setting for each parameter. The actual-parameter input setting 144 is to input the actual setting of the each parameter. The actual-parameter computation setting 146 is to compute the actual value of the parameter. The objective-predicted comparison setting 148 is used to set a comparison for each prediction of objective. The actual-objective comparison setting 150 is to set a comparison of actual value of every objective.

The SWOT-matrix module 16 is a critical component that certifies the Balanced Score-Card system can be accurately established. The SWOT-matrix module 16 in accordance with the present invention is a component that has logical and recording mechanism. This SWOT-matrix module 16 is set with weights in compliance with the items of the four major classes, which are Strengths, Weaknesses, Opportunities, and Threats. The strategic-matching module is to evaluate the expected alternative strategies, and then to operate an attractiveness analyzer by the alternative strategies in order to confirm the primary and secondary strategies. After that, the system performs a matching on the primary strategy, secondary strategy, and the strategic subject. Therefore, when the practical situation of the analytic item decided by the enterprise is not as expected, only the SWOT-matrix module 16 can be used to find out why the erroneous analytic item was defined. After that, the analytic item is modified and re-matching based on the SWOT-matrix module 16.

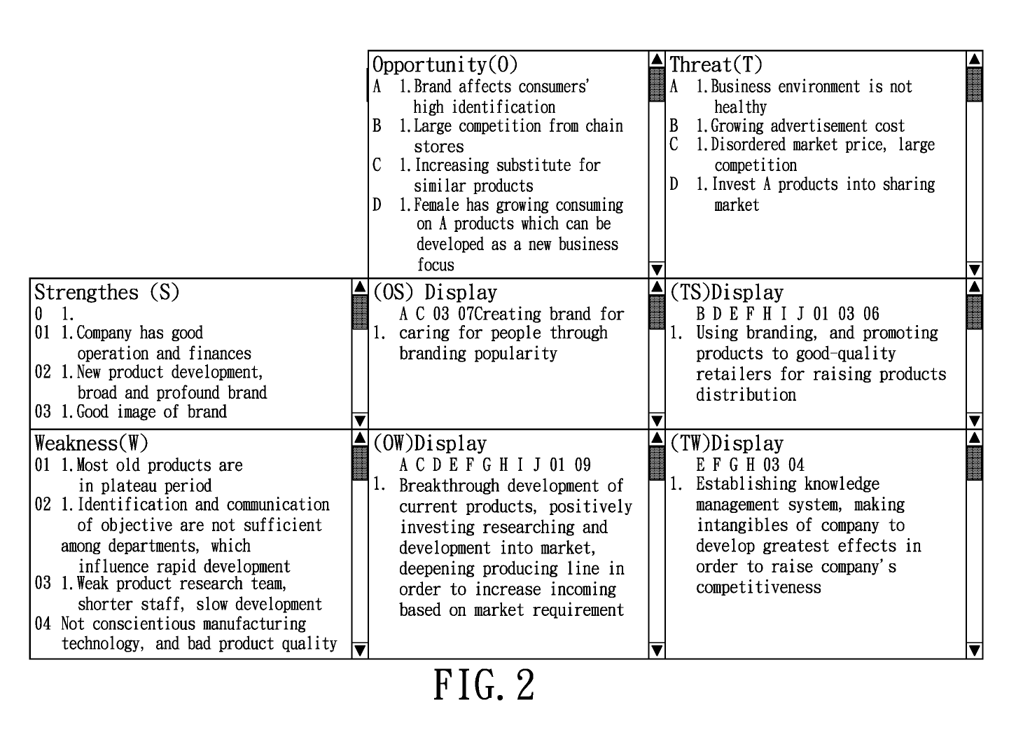

Reference is made to FIG. 2 showing a preferred embodiment of the SWOT-matrix module in accordance with the present invention. The SWOT-matrix module 16 in the invention are classified as four major classes, such as Strengths (S), Weaknesses (W), Opportunities (O) and Threats (T). The different numbers or characters are defined prior to every analytic item being listed in each major class. As shown in the diagram, the numbers 1, 2, and the like will be defined before the every analytic item for the Strengths and Weaknesses classes is listed. Further, the characters A, B, and the like are defined before every analytic item for the Opportunities and Threats classes is listed. Therefore, when the SWOT-matrix module 16 establishes the four major strategies, including competitive superiority (OS), crisis turning-point (TS), competitive weaknesses (OW), and immediate crisis (TW), the combination of the numbers or characters are defined prior to setting one objective of the strategies. For example, the first strategic objective of the competitive superiority (OS) is a combination of AC37.

When every strategic objective of the four major strategies has already been defined, the enterprises may find out there is no any specific number or character in the strategic objective by comparison. In an exemplary example, if there is no character “B” or number “4” can be found in the strategic objective defined in the competitive superiority (OS), it means the previous defined analytic item that has the character “B” or number “4” is an error, or no any previous definition was set on the related analytic item. In view of mentioned error, it can be back to the step prior to the situation when the strategic objective was defined, and the corresponding analytic item can be modified. When the practice of strategic objective made by the entrepreneur is not as expected, the step can be back to find out the analytic item with possible error in view of the combination of number and character. Furthermore, the SWOT-matrix module 16 provides a function of counting the times of using the strategic condition. This function provides the enterprise to obtain the defined analytic item with highest times in every strategy. Therefore this analytic item has the significant information regarding the business success or failure.

The strategic-matching module 17 in accordance with the present invention is based on the SWOT-matrix module 16. In which, the first step in the method is to set weight and conduct an evaluation on every analytic item of SWOT. After that, a total weighted score EFE (External Factor Evaluation) of the external circumstance such as opportunity and threat and other score IFE (Internal Factor Evaluation) can be obtained. In the second step, the MI is an X-axis, and EFE is a Y-axis. The X-Y diagram is used to find out the strategic position and strategic subject of enterprise. The third step in the method is to conduct evaluation on attractiveness of each strategic subject for obtaining weight of each subject. After that, the result is transferred to the strategic scheme of SWOT-matrix module 16 for performing matching.

SWOT overall-objective setting module 18 is used to set up the SWOT overall objective by means of the SWOT-matrix module 16 with recording mechanism. The overall-objective setting module 20 is connected with the index-related setting 108 and the SWOT overall-objective setting module 18, in order to set up the overall objective of Balanced Score-Card system. The objective-deconstruction module 22 is to deconstruct every strategic objective of the overall-objective setting module 20. The causality setting module 24 is connected to the overall-objective setting module 20. The causality of every strategic objective in the overall-objective setting module 20 can be set up based on index-related setting 108. The strategic-map module 26 automatically creates a strategic map based on the logic of causality of each strategic objective. The strategic map is then outputted to the front module 28 of the Balanced Score-Card for displaying. The multidimensional data-analysis module 30 is used to receive the result outputted from the product-analysis module 12.

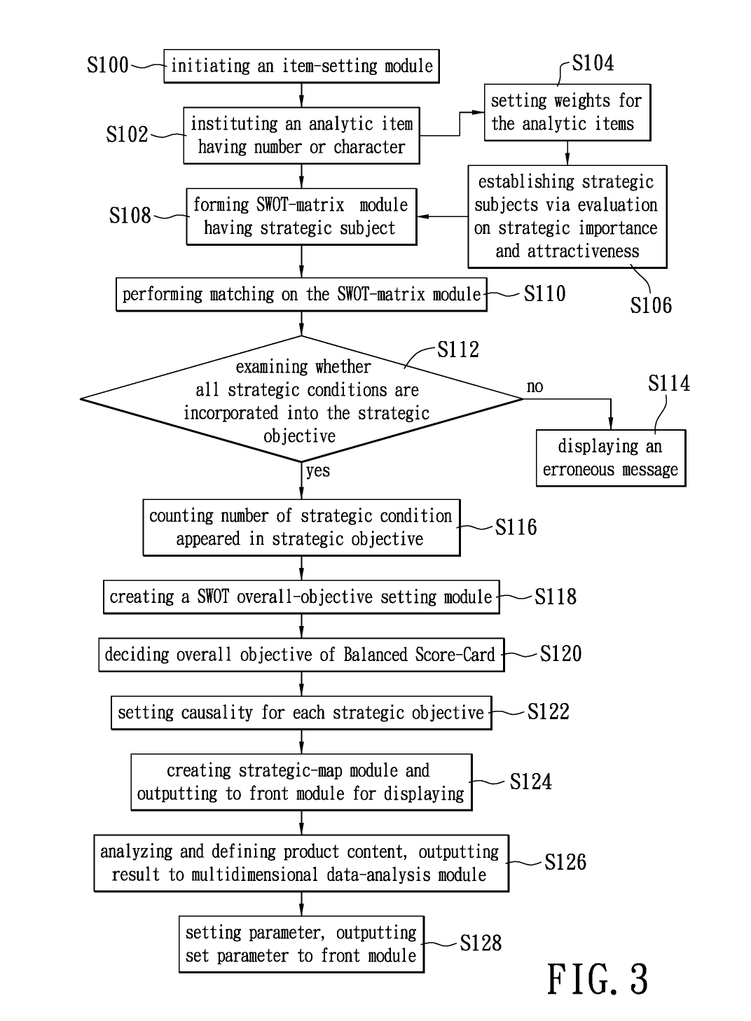

Reference is made to both FIG. 1 and FIG. 3. The FIG. 3 is a flow chart of the method for establishing the Balanced Score-Card. Firstly, an item-setting module (10) is initiated in step S100. The item-setting module (10), as the above description, includes a computing-unit setting (100), a strategic planning version (102), a computing parameter definition (104), an index setting (106), and an index-related setting (108). Next, the user, such as an entrepreneur, institutes the analytic item having at least one number or character through the claimed Balanced Score-Card system (step S102). The Balanced Score-Card system lists the strategic objective for each of the competitive superiority (OS), crisis turning-point (TS), competitive weaknesses (OW), and instant crisis (TW) based on the analytic item selected from the four classes including Strengths, Weaknesses, Opportunities, and Threats. Weights for those analytic items are set via a strategic-matching module in the step S104. A plurality of strategic subjects are established via the evaluation on the strategic importance and attractiveness (step S106). According to the step S104, one SWOT-matrix module having the plurality of strategic objectives is established (step S108). After that evaluation, at least one strategic subject is formed for performing matching on the SWOT-matrix module (16) (step S110).

After that, it is to examine whether all the above-described strategic conditions are incorporated into the strategic objective (step S112). If the result of the examination is positive, it's to count the number of the strategic condition appeared in the strategic objective (step S116). Otherwise, if the result of examination is negative, an erroneous message is displayed (step S114). In step S108, the user may understand that the analytic item is not used by the SWOT-matrix module (16) from the erroneous message. That is, the disappeared analytic item is due to the initial error setting, or the user forgot to set the analytic item initially. Further, in the step S114, the user can understand the importance of any one analytic item in view of the number of the analytic item appeared in the strategic objective of the SWOT-matrix module 16.

Therefore, after going through the above steps S112 to S116, the user may backstep to every analytic item to examine whether the analytic item has error in the initial step or not when practice of the strategic objective made by the user is not as expected.

Next, in the step S118, a SWOT overall-objective setting module 18 is created through the SWOT-matrix module 16. According to the index-related setting 108 of the item-setting module 10 and the SWOT overall-objective setting module 18, an overall objective of the claimed Balanced Score-Card is decided (step S120). The system further sets causality for each strategic objective for establishing a causality setting module (step S122). After that, a strategic-map module 26 can be automatically created in compliance with logic of the causality for each strategic objective. The strategic map is then outputted to the front module 28 of the Balanced Score-Card for displaying (step S124). Particularly, a strategic planning version 102 of the item-setting module 10 is referred to analyze and define the product content. The result of analysis is then outputted to a multidimensional data-analysis module 30 (step S126). Moreover, a computing parameter definition 104 of the item-setting module 10 is used to set every type of parameter, and the set parameters are outputted to the front module 28 (step S128).

The SWOT-matrix module 16 of Balanced Score-Card system in accordance with the present invention has the advantages as listed:

First, every strategic objective has attached with many numbers and characters, which are used to establish the logical relation between the strategic objective and the analytic items.

Second, the every analytic item in the strategic objective has attached with a computation number which is used to represent an opposite important analytic item.

Third, the SWOT-matrix module is equipped with the function of reversible deduction, which is capable of examining whether the initial setting has error when the strategic objective made by the user is not as expected.

To sum up, the SWOT-matrix module claimed in the present invention makes the user not only easily obtain the logical relation between the strategic objective and the analytic item, but also figure out the importance of every analytic item. And particularly, the module can examine whether the analytic item has error or not.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A Balanced Score-Card system, comprising:
an item-setting module, having an index-related setting;
a SWOT-matrix module, having a logical relations and a recording mechanism;
a strategic-matching module, connected to the SWOT-matrix module, for receiving an evaluation transmitted from the SWOT-matrix module and transmitting a matching status to the SWOT-matrix module according to evaluation;
a SWOT overall-objective setting module, connected to the SWOT-matrix module, for setting a SWOT overall objective;
an overall-objective setting module, connected to the index-related setting and the SWOT overall-objective setting module, for setting an overall objective of the Balanced Score-Card system;
a causality setting module, connected to the overall-objective setting module, for setting a causality for each strategic objective in the overall-objective setting module according to the index-related setting; and
a strategic-map module for automatically generating a strategic map according to a logic of causality of each strategic objective, and outputting the strategic map to a front module of the balanced Score-Card for displaying.

2. The system of claim 1, wherein the item-setting module further comprises a computing-unit setting, a strategic planning version, a computing parameter definition, and an index setting.

3. The system of claim 2, further comprising a product-analysis module, which is used to analyze and define product content, and output result of analysis to a multidimensional data-analysis module according to the strategic planning version.

4. The system of claim 3, wherein the product-analysis module comprises a product-classified setting, a product-information setting, a customer-information setting, a product-version-information setting, and a turnover setting.

5. The system of claim 2, further comprising a parameter-setting module for receiving the computing parameter definition in order to set parameters, and outputting the set parameters to a front module of the Balanced. Score-Card.

6. The system of claim 5, wherein the parameter-setting module comprises a parameter-participant-combination setting, a parameter-predicted input setting, an actual-parameter input setting, an actual-parameter computation setting, a objective-predicted comparison setting, and an actual-objective comparison setting.

7. The system of claim 1, further comprising a objective-deconstruction module for decomposing every strategic objective of the overall-objective setting module.

8. A method for establishing a Balanced Score-Card, comprising:
setting an item-setting module;
instituting one or more analytic items having at least one number or character;
establishing at least one SWOT-matrix module of a strategic objective based on the analytic items having numbers or characters;
setting a SWOT overall-objective setting module through the SWOT-matrix module;
setting an overall objective of the Balanced Score-Card based on an index-related setting of the item-setting module and the SWOT overall-objective setting module;
setting causality for every strategic objective for establishing a causality setting module; and
automatically establishing a strategic-map module based on the causality of every strategic objective, and outputting the strategic map to a front module of the Balanced Score-Card for displaying.

9. The method of claim 8, wherein the step of establishing the SWOT-matrix module of the strategic objective based on the analytic items having numbers or characters further comprises a step of examining whether all the analytic items are incorporated into the strategic objective.

10. The method of claim 9, wherein the step of examining the analytic items, if the analytic items are truly incorporated into the strategic objective, the method is to count the number of the analytic items appeared in the strategic objective; if the analytic items are not incorporated into the strategic objective, an error message is displayed.

11. The method of claim 8, further comprising:
obtaining at least one strategic subject after verifying weights of the analytic items and evaluation through a strategic-matching module, the method is to perform a matching of the SWOT-matrix module;
analyzing and defining product content based on a strategic Planning Version of the item-setting module, and outputting the analysis to a multidimensional data-analysis module; and
receiving a computing parameter definition of the item-setting module for setting parameters, and outputting the parameters to the front module.
